(19) United States
(12) Patent Application Publication
(10) Pub. No.: US 2026/0256313 A1
(43) Pub. Date: Sep. 3, 2026

(54) DEVICE FOR BREWING HOT DRINKS

(71) Applicant: WE ARE LOKA LIMITED, Stratford-Upon-Avon (GB)

(72) Inventors: Andrew AITKEN, Hamilton (NZ); Chifen CHENG, London (GB); Jonathan MARSHALL, London (GB); Anish SHONPAL, London (GB); Nikhil SHAH, London (GB)

(21) Appl. No.: 19/165,492

(22) PCT Filed: Mar. 6, 2024
(86) PCT No.: PCT/IB2024/052163

§ 371 Date: Sep. 15, 2025

(30) Foreign Application Priority Data
Mar. 14, 2023 (GB) 2303752.6

(51) Int. Cl. A47J 31/06

(52) U.S. Cl. CPC A47J 31/0631

(57) ABSTRACT

Aspects of the present invention provide a device and method for brewing hot drinks The device comprises: a receptacle for holding a liquid, the receptacle comprising a base that sits on a heat source and a mouth defining an opening opposite the base; a basket positionable within the opening and extending into the receptacle; and a support structure surrounding the basket, the support structure comprising one or more openings through which liquid may pass upwardly from the receptacle as the liquid boils and subsequently downwardly into the basket as the liquid cools, the support structure further being arranged to substantially surround and support the basket.

### FIELD

The present invention relates to a device for brewing chai (or tea) and other hot drinks.

### BACKGROUND

Chai is a traditional Indian tea that is made by brewing black tea leaves with a mixture of spices, such as cinnamon, cardamom, ginger, cloves, and black peppercorns. One method of brewing chai tea comprises: i) bringing a volume of water to boil in a saucepan; ii) adding tea bags (or loose leaf tea) and spices to the boiling water; iii) reducing the heat and allowing the liquid to simmer for a pre-determined period of time; iv) adding milk and sugars/sweeteners to the liquid; v) increasing the heat and bringing the liquid back to boil; vi) removing the saucepan from the heat and allowing the tea to steep; and vii) straining the brewed tea through a fine-mesh strainer into a serving mug. Another method of brewing chai comprises: i) adding tea, milk, water, and spices to a saucepan; ii) bringing the ingredients to boil; iii) reducing the heat and allowing the liquid to simmer for a pre-determined period of time; iv) removing the saucepan from the heat; and v) straining the brewed tea through a fine-mesh strainer into a serving mug.

Milk based drinks are known to froth and boil over the edge of a pan, or other receptacle, when heated. Milk froths when it boils because of the proteins and sugars it contains. As milk heats, the proteins denature (unwind) and start to bond with one another. At the same time, gas bubbles are introduced into the milk, either through stirring or due to the rapid expansion of the liquid as it reaches boiling point. The denatured proteins form a foam around the gas bubbles, creating a froth on the surface of the milk.

When the milk reaches boiling point, the temperature causes the proteins to fully coagulate and the gas bubbles become trapped within the foam, creating a stable froth. If the milk continues to boil, the foam will become denser, and eventually collapse.

In some cases, the frothing of milk can be desirable, such as in making cappuccinos or lattes, where the foam provides a creamy texture and enhances the overall taste of the drink. In other cases, such as when making sauces or custards, and some drinks, it may be undesirable, as the frothing can cause the liquid to boil over or become too thick. When this happens, a proportion of the liquid is lost and is required to be cleaned up.

There are several conventional methods that may be used to stopping boil over of milk. Stirring: Stirring the milk frequently can break up gas bubbles and help prevent a skin from forming on top of the milk and causing it to boil over. Lowering the heat: Reducing the heat of the stove can help prevent the milk from boiling too rapidly. You can also turn off the heat for a few moments if you notice that the milk is about to boil over. Using a larger saucepan: If you are using a small saucepan for a large amount of milk, it is more likely to boil over. Using a larger saucepan can provide more space for the milk to expand. Adding salt or a drop of oil: Adding a pinch of salt or a drop of oil to the milk can reduce the surface tension and prevent it from boiling over. Using a splatter screen: Placing a splatter screen or a lid on top of the saucepan can also help prevent the milk from boiling over. Make sure to leave a small gap for steam to escape.

Despite one's best efforts, boiling milk can be unpredictable and boil overs can still occur. It is therefore important to stay close to a pan to enable remedial action to be taken should it be observed that a boil over is imminent.

It is against this background that the present invention has arisen.

### SUMMARY

An aspect of the invention comprises a device for brewing hot drinks, the device comprising: a receptacle for holding a liquid, the receptacle comprising a base that sits on a heat source and a mouth defining an opening opposite the base; a basket for holding one or more food or drink ingredients and positionable within the opening such that the basket extends into the receptacle; and a support structure surrounding the basket, the support structure comprising one or more openings through which liquid may pass upwardly from the receptacle as the liquid boils and subsequently downwardly into the basket as the liquid cools, the support structure further being arranged to substantially surround and support the basket.

The claimed device is advantageous over prior art devices for brewing hot drinks due to its unique structure and design features. The device comprises a receptacle for holding the liquid, which is designed to sit on a heat source, with a mouth defining an opening opposite the base. The basket for holding one or more food or drink ingredients is positioned within the opening and is held in place by the support structure extending around the inside of the mouth of the receptacle. The support structure further comprises at least one opening, i.e., slots, which allow the liquid to pass upwardly from the receptacle as it boils, and then downwardly into the basket as it cools. This design allows for efficient and consistent brewing of hot drinks by ensuring that the ingredients are constantly infused with the hot liquid. The support structure also provides additional support for the basket, ensuring that it remains securely in place during the brewing process.

In one embodiment, the receptacle comprises a first part comprising the base and holding liquid content and a second part comprising a removable top that includes the mouth, basket, and annular lip.

The ability to remove the top part of the receptacle makes it easier to clean and maintain the device. This is especially beneficial if the device is used frequently and for a variety of different hot drinks, as it allows for easy cleaning between uses. Furthermore, the removable top part of the receptacle allows for more convenient and flexible use of the device. For example, the top part can be easily removed and replaced with another basket or accessory, allowing the user to customize the device to suit their specific needs. The removable top part of the receptacle also makes it easier to transport and store the device, as the top part can be removed, and the base part of the receptacle can be more easily packed and stored. This enhances the portability and convenience of the device, making it more appealing to users who are looking for a compact and easy-to-use solution for brewing hot drinks.

In one embodiment, the base comprises an open face opposite the base that in turn comprises a support surface upon which the second part is supported.

The support surface on the open face of the base provides a stable and secure platform for the second part of the receptacle, ensuring that it remains in place during the brewing process. This helps to prevent spills and leaks, making the device safer and more reliable to use.

In one embodiment, the basket comprises a frustoconical or cylindrical structure having an open top surface and a closed bottom surface and a tapered wall there between, the tapered wall and the base comprising a plurality of apertures configured to allow liquid from the first part of the device to permeate.

The apertures in the tapered wall and the base allow for easy permeation of the liquid from the first part of the device into the basket, ensuring that the food or drink ingredients are effectively infused with the liquid. This improves the overall performance of the device and ensures that the hot drinks are brewed to a high standard. Furthermore, the closed bottom surface of the basket helps to prevent most of the solid food or drink ingredients from leaking into the first part of the receptacle, thereby ensuring that the device is easier to clean and maintain. Additionally, the closed bottom surface also helps to prevent any unwanted mixing of the ingredients with the liquid in the first part of the receptacle. The nature of chai requires small particles of spices to infuse with the liquid base of the drink. However, large pieces and particles of spices are unwanted and can negatively affect the quality and enjoyment of the brewed drink. Consequently, the apertures are sized to prevent pieces and particles of spices above a pre-determined size from passing through into the liquid whereas smaller particles of spices may pass freely through the apertures and infuse into the liquid.

In one embodiment, the support structure comprises a baffle that extends upwardly from an annular lip projecting inwardly from the mouth of the lower part of the receptacle, the baffle substantially enclosing the basket, in use.

The baffle helps to prevent splashing and spilling of the liquid as it boils and rises through the one or more openings through the support structure and drops back into the basket. This enhances the safety and reliability of the device and helps to prevent unwanted mess and waste.

In one embodiment, either the support structure or the basket further comprises an annular ring surrounding the open top surface thereof.

As the liquid boils and froths, it rises as a foam out of the lower part of the device before cooling and falling back down into the basket as a liquid via the annular ring. This has the advantage of breaking up the froth and creating a smooth, creamy texture in the chai. Furthermore, the annular ring provides an increased surface area over which the foam can be thermally exposed to the regions surrounding the liquid, and thus be cooled. This has the effect of both popping or bursting bubbles within the foam and shrinking the size of gas bubbles within the foam. Together, the thermal exposure and breaking up of the froth ensures that froth build up is controlled and there is a consistent cycle of froth rising upwardly out of the lower part of the devices and liquid falling back into the lower part of the device over the spices held within the basket.

In one embodiment, a channel is defined between an internal perimeter wall of the upper part and the baffle surrounding the basket, wherein liquid and/or foam content from the lower part, when heated near boiling point, rises upwardly through the slots in the annular lip and is guided through the channel.

The channel provides a controlled and consistent flow of the liquid, helping to prevent splashing and spilling and ensuring that the hot drinks are brewed evenly and efficiently. Furthermore, the liquid-which when near boiling point froths-is broken up as it passes through the slots and within the channel to prevent build up of foam. Without this it would inhibit a fountain effect whereby the liquid froths as it is heated and falls back into the basket over the spices when it cools. This enhances the safety and reliability of the device and helps to prevent unwanted mess and waste. The channel also helps to maintain a stable temperature of the liquid, ensuring that the hot drinks are brewed to a consistent and optimal temperature. This enhances the overall performance and functionality of the device and ensures that the hot drinks are of a high quality.

In one embodiment, one or more obstacles or objects is positioned in the channel to restrict flow of the liquid.

Positioning one or more obstacles or objects in the flow path of the liquid can have several advantages. Such an arrangement can help to create turbulence in the liquid, which can aid in the extraction of flavour and aroma from the spices and tea leaves. This can lead to a more robust, creamy, and flavourful cup of chai. Also, by restricting or redirecting the flow of the liquid, these obstacles or objects can help to prevent the liquid from boiling over or spilling out of the device. This is particularly important in traditional chai brewing methods, which involve simmering the chai for an extended period of time.

In one embodiment, the removable top comprises a base that is supported by the support surface and a perimeter wall extending from the base that is substantially bowl-shaped and defines a reverse curve profile.

The reverse curve profile helps to prevent splashing and spilling of the liquid, as it acts as a barrier that contains the liquid and directs its flow. This enhances the safety and reliability of the device and helps to prevent unwanted mess and waste. The reverse curve profile of the perimeter wall also provides a sleek and ergonomic design that enhances the aesthetic appeal of the device and makes it more appealing to users.

In one embodiment, the device comprises a watertight seal between the first part and the second part.

The watertight seal helps to prevent leaks and spills, enhancing the safety and reliability of the device and helping to prevent unwanted mess and waste. The watertight seal also helps to maintain the temperature and pressure of the liquid within the device, ensuring that the hot drinks are brewed to a consistent and optimal temperature and to a high standard.

In one embodiment, the device comprises a locking mechanism between the first part and second part to allow the first and second part to be releasably locked together.

The locking mechanism helps to ensure that the watertight seal between the first and second parts is maintained, ensuring that the temperature and pressure of the liquid within the device are maintained and that the hot drinks are brewed to a consistent and optimal temperature and to a high standard. The locking mechanism also provides a secure and reliable connection between the first and second parts, enhancing the safety and reliability of the device and helping to prevent leaks and spills. The locking mechanism also provides a convenient way to join the first and second parts of the device, as it helps to secure them together and prevent detachment when the device is moved from a stove to pour its contents into a drinking container, for example.

In one embodiment, the second part further comprises a handle extending outwardly therefrom.

The handle makes it easier to carry and transport the device, as it provides a convenient way to hold and manoeuvre the device. The handle also helps to reduce the risk of burns and injuries, as it provides a safe and secure way to handle the hot device.

### FIGURES

The figures provided in this specification serve to further illustrate and explain the various aspects and embodiments of the present invention. In particular, the following figures depict several embodiments of the disclosed self-locking joint. It is understood that the specific configurations and details shown in the figures are not intended to be limiting, and that other variations and modifications of the invention are possible.

FIG. 1 illustrates an isometric view of a device for brewing hot drinks according to the disclosure.

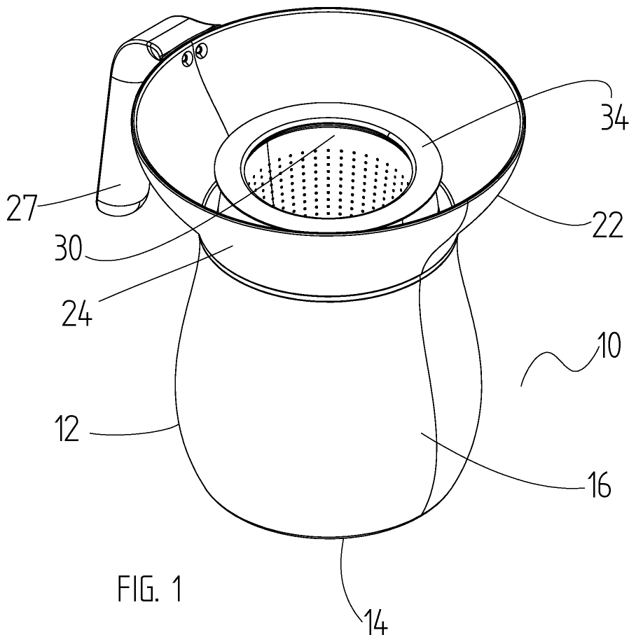

FIG. 2 illustrates an exploded isometric view of the device of FIG. 1.

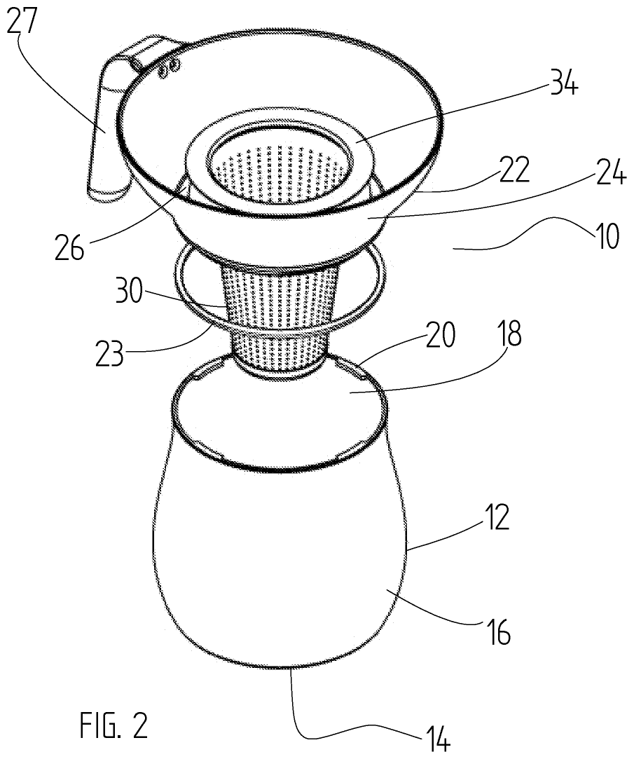

FIG. 3 Illustrates another view of the device of FIGS. 1 and 2.

FIG. 4 illustrates a cross-section of the device of FIGS. 1 and 2.

FIG. 5 illustrates a method of operation of the device of FIGS. 1 to 3.

### DESCRIPTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

As shown in the figures, an aspect of the present invention relates to a device (10) for brewing hot drinks and/or cooking dried foods. The device (10) comprises lower part (12) that consists of a base (14), perimeter wall (16) extending upwardly from the base (14), and an open mouth (18) opposite the base (14). The base (14) comprises a heat conductive material for conducting heat from a heat source, i.e., a hob, to liquid contained within the lower part (12). The side wall (16) comprises a material that may have a lower heat conductivity than the base (14). However, in some embodiments the side wall (16) may have greater heater conductivity than the base (14). In some embodiments the heat conductivity of the side wall (16) and base (14) may be equal. The open mouth (18) comprises at least one support (20) for allowing an upper part (22) to be stacked on top of the lower part (12), in use. A watertight seal (23) is positioned between the upper and lower parts (12, 22) of the device (10). As shown in the figures, the lower part (12) comprises four inwardly facing supports (20) spaced equidistantly around the Internal circumference of the open mouth (18) of the lower part (12).

The upper part (22) comprises a perimeter wall (24) that has a first diameter at a first end thereof that is concentric with the diameter of the lower part (12). The perimeter wall (24) has a second diameter at second end thereof by virtue of a flared section between the first and second ends of the perimeter wall (24). The first end of the perimeter wall defines an annular lip (26) that projects inwardly of the perimeter wall (24). A handle (27) is riveted, screwed, or otherwise fastened to the outer perimeter wall (24) of the upper part (22). The upper part (22) has a generally bowl-shaped profile having a first diameter at its base and a second diameter at its mouth, wherein the profile between the base and mouth of the upper part (22) forms a reverse curve profile.

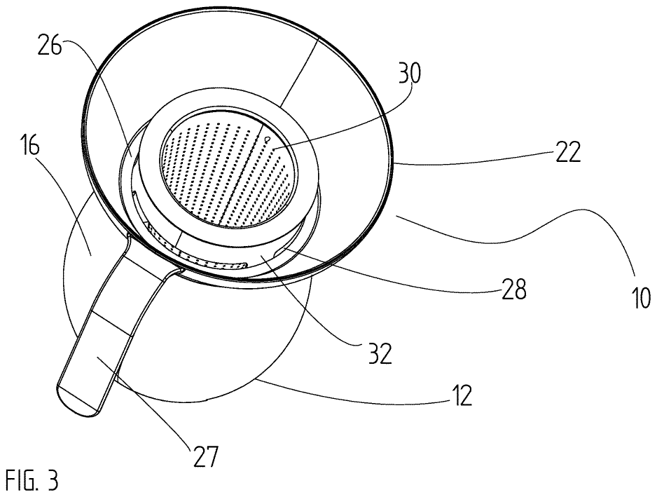

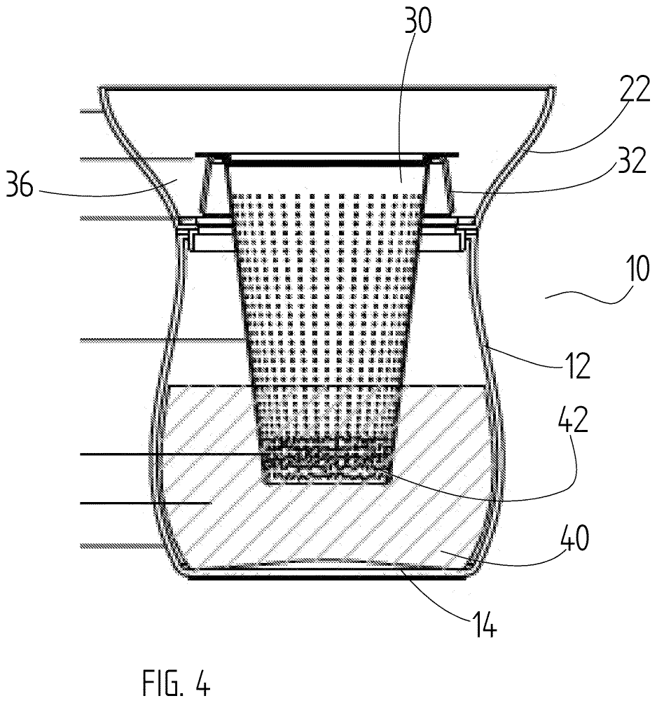

A basket (30) may be inserted through an opening defined by the annular lip (26). The basket (30) is generally frustoconical or cylindrical in shape and has a first diameter at the upper end thereof and a second, lesser diameter at the lower end thereof. The basket (30) may be supported by the annular lip (26) at a point on the perimeter of the basket (30) where the diameter of the basket (30) intersects the diameter of the opening. The lower end of the basket (30) thus penetrates the lower part (12) of the device, in use. The basket further comprises a plurality of holes, apertures, or cutouts to allow liquid in the lower part (12) of the device (10) to permeate the basket (30). The basket (30) may be separable from the upper part (22) or integrated into the upper part (22). As shown in the figures, the basket (30) is positioned such that part of the basket (30) is self-contained within the upper part (22) and part of the basket (30) extends through and below the upper part (22). The part of the basket that is self-contained within the upper part (22) is surrounded on its sides by a support structure, i.e., a baffle (32), which is liquid impermeable. The baffle (32) comprises several slots or cutouts (28) through which liquid may pass as it is heated near boiling point and froths and expands. This is more clearly shown in FIG. 3. In other examples, the annular lip (26) and/or the baffle (32) comprise one or more slots or cutouts (28) to allow liquid to pass from the lower part (12) of the device (10) to the upper part (22). An annular ring (34) surrounds the open top face of the basket (30) and is shown in the figures as being part of the support baffle (32). In other embodiments the annular ring (34) may be part of the basket (30). Consequently, liquid that boils out of the lower part (12) is guided upwardly through a channel (36) defined between the baffle (32) and inner perimeter wall (38) of the upper part (22) and as the liquid cools it passes back into the basket (30) over the annular ring (34) and over the content of the basket (30) and back into the lower part (12). The action of the liquid passing over the annular ring (34) causes the gas bubbles in any froth to be broken down before the liquid comes back into contact with the spices within the basket (30). The channel (36) is identified in FIG. 4.

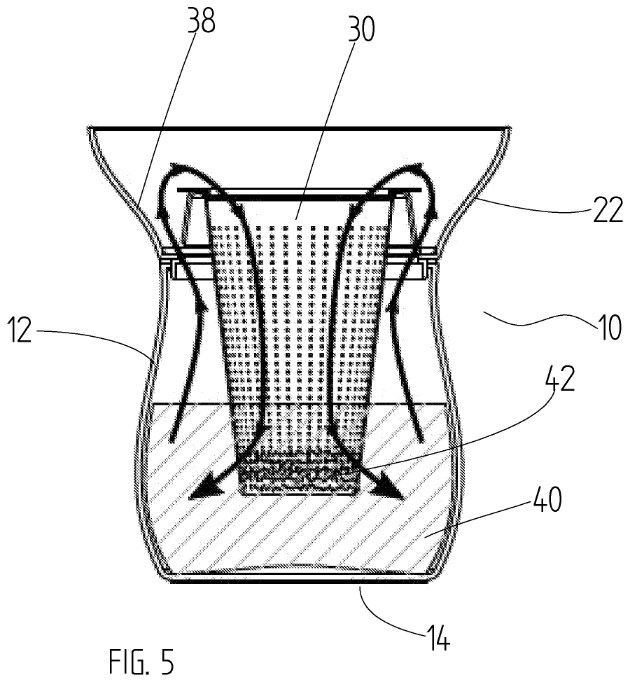

In use, the lower part (12) is filled with a body of liquid (40). In the case of a chai tea drink, the body of liquid comprises water and milk. The basket (30) is at least partially filled with tea and spices (42). The device (10) is placed on a stove (or other heat source) to heat the liquid (40). As the liquid heats (40), the tea and spices (42) are infused into the liquid (40). When the liquid (40) reaches near boiling point, it will froth and rise upwardly from the lower part (12) through the slots or cutouts (28) of the annular lip (26) into the upper part (22). As the liquid (40) rises away from the heat source it is allowed to cool before sinking back into the lower part (12) by way of the basket (30). As the liquid passes through the slots (28) from the lower part (12) into the upper part (22) and is guided upwardly by the channel (36) and over the annular ring (34) some of the bubbles remaining within the liquid are popped or burst thus avoiding buildup of foam which can block flow of the liquid within the device (10) as it reaches near boiling point and froths. The action of the liquid frothing as it is boiled and subsequently falling back into the basket when it cools is shown in FIG. 5.

The above embodiments are exemplary only, and other possibilities and alternatives within the scope of the appended claims will be apparent to those skilled in the art. For example, the described embodiments may each utilize features that are common across the embodiments. This is more clearly depicted in the figures.

1. A device for brewing hot drinks, the device comprising: a receptacle for holding a liquid, the receptacle comprising a base that sits on a heat source and a mouth defining an opening opposite the base; a basket for holding one or more food or drink ingredients and positionable within the opening such that the basket extends into the receptacle; and a support structure surrounding the basket, the support structure comprising one or more openings through which liquid may pass upwardly from the receptacle as the liquid boils and subsequently downwardly into the basket as the liquid cools, the support structure further being arranged to substantially surround and support the basket.

2. A device for brewing hot drinks according to claim 1, wherein the receptacle comprises a first part comprising the base and holding liquid content and a second part comprising a removable top that includes the mouth, basket, and annular lip.

3. A device for brewing hot drinks according to claim 2, wherein the base comprises an open face opposite the base that in turn comprises a support surface upon which the second part is supported.

4. A device for brewing hot drinks according to any preceding claim, wherein the basket comprises a frustoconical or cylindrical structure having an open top surface and a closed bottom surface and a tapered wall therebetween, the tapered wall and the base comprising a plurality of apertures configured to allow liquid from the first part of the device to permeate.

5. A device for brewing hot drinks according to claim 4, wherein either the support structure or the basket further comprises an annular ring surrounding the open top surface thereof.

6. A device for brewing hot drinks according to claim 5, wherein a channel is defined between an internal perimeter wall of the upper part and the support structure surrounding the basket, wherein liquid and foam from the lower part, when heated near boiling point, rises upwardly through the slots in the support structure and is guided through the channel.

7. A device for brewing hot drinks according to claim 6, wherein one or more obstacles or objects is positioned in the channel to restrict flow of the liquid.

8. A device for brewing hot drinks according to claim 3, wherein the removable top comprises a base that is supported by the support surface and a perimeter wall extending from the base that is substantially bowl-shaped and defines a reverse curve profile.

9. A device for brewing hot drinks according to claim 8 further comprising a watertight seal between the first part and the second part.

10. A device for brewing hot drinks according to claim 9, further comprising a locking mechanism between the first part and second part to allow the first and second part to be releasably locked together.

11. A device for brewing hot drinks according to claim 10, wherein the second part further comprises a handle extending outwardly therefrom.
